(19) United States
(12) Patent Application Publication
(10) Pub. No.: US 2016/0203643 A1
(43) Pub. Date: Jul. 14, 2016

(54) EXHIBITION GUIDE APPARATUS, EXHIBITION MEDIA DISPLAY APPARATUS, MOBILE TERMINAL AND METHOD FOR GUIDING EXHIBITION

(71) Applicant: ELECTRONICS AND TELECOMMUNICATIONS RESEARCH INSTITUTE, Daejeon-si (KR)

(72) Inventors: Sung Hee KIM, Daejeon-si (KR); Hyung Keuk LEE, Seoul (KR); Hyun Woo LEE, Seoul (KR)

(21) Appl. No.: 14/726,934

(22) Filed: Jun. 1, 2015

(30) Foreign Application Priority Data
Jan. 13, 2015 (KR) 10-2015-0006396

(51) Int. Cl. G06T 19/00

(52) U.S. Cl. CPC G06T 19/006

(57) ABSTRACT

An exhibition guide apparatus, an exhibition media display apparatus and a mobile terminal are provided. The exhibition guide apparatus communicates with the exhibition media display apparatus and the mobile terminal and includes: a virtual exhibition creator configured to create a virtual exhibition hall using a digital map that contains space information about an exhibition hall and arrangement information of exhibition objects displayed in the exhibition hall; a viewing route creator configured to create at least one viewing route according to a movement of a tracking icon that indicates a location of a user in the virtual exhibition hall; and an exhibition space mirroring module configured to mirror viewing guide information that contains at least one of the following: information about the virtual exhibition hall, the viewing route and detailed information about an exhibition hall.

### CROSS-REFERENCE TO RELATED APPLICATION(S)

This application claims priority from Korean Patent Application No. 10-2015-0006396, filed on Jan. 13, 2015, in the Korean Intellectual Property Office, the disclosure of which is incorporated herein by reference in its entirety.

### BACKGROUND

1. Field

The following description relates to an exhibition guide system, and more particularly, an exhibition guide apparatus, an exhibition media display apparatus, and a mobile terminal.

2. Description of the Related Art

Information on exhibition objects displayed at a museum or at an exhibition is provided with simple descriptions of pictures or text attached on the exhibition wall, such that the information or knowledge may not be provided in depth. In order to solve the drawback, a ubiquitous computing system has been developed to provide exhibition visitors with various multimedia services. Examples of the ubiquitous computing system include a touchscreen kiosk, a cyber-guide system using the Internet, a voice guide device using MP3 files, a PDA-based guide system, and the like.

Augmented reality (AR) refers to a technology that combines a virtual object or virtual information into a real-world environment such that the virtual object or virtual information looks like a real object or real information that exists in the real environment. That is, AR displays 3-dimensional virtual object by overlapping it on the real-world environment. AR is characterized by synthesizing virtual objects based on the real world to provide additional information that cannot easily be obtained from the real world, unlike existing Virtual Reality (VR) that targets only virtual spaces and virtual objects. Due to such characteristic, AR can apply to various real-world environments, unlike VR that has only limited applications, such as games, and especially AR is regarded as the next generation display technology suitable for the ubiquitous environment.

### SUMMARY

The following description relates to an apparatus and method for providing an exhibition space as a virtual space, and augmenting the virtual space with real exhibition objects.

In addition, the following description relates to an apparatus and method for allowing viewers to view exhibition objects in a virtual exhibition hall according to their own purpose.

Further, the following description relates to an apparatus and method for providing viewers with a virtual exhibition hall augmented with real exhibition objects, thereby enabling the viewers to obtain information about layouts and conditions of the actual exhibition space and exhibition objects without physically visiting the “real-world” exhibition hall.

In one general aspect, there is provided an exhibition guide apparatus that communicates with an exhibition media display apparatus and a mobile terminal, the exhibition guide apparatus including: a virtual exhibition creator configured to create a virtual exhibition hall using a digital map that contains space information about an exhibition hall and information about arrangement (hereinafter, referred to as “arrangement information”) of exhibition objects displayed in the exhibition hall; a viewing route creator configured to create at least one viewing route according to a movement of a tracking icon that indicates a location of a user in the virtual exhibition hall; and an exhibition space mirroring module configured to mirror viewing guide information to the exhibition media display apparatus, the viewing guide information containing at least one of the following: information about the virtual exhibition hall, the viewing route and detailed information about an exhibition hall.

The virtual exhibition hall creator may create the virtual exhibition hall by augmenting the virtual exhibition hall with real exhibition objects according to the arrangement information of exhibition objects.

The exhibition guide apparatus may further include a tracking icon creator configured to create the tracking icon associated with identification information of the mobile terminal to indicate a location of the mobile terminal in the exhibition hall and a tracking information transmitter configured to transmit tracking-related information that contains the tracking icon to both the exhibition media display apparatus and the mobile terminal.

The exhibition guide apparatus may further include a mobile-terminal-location-information receiver configured to receive mobile terminal's location information from the mobile terminal and a detailed-exhibit-information generator configured to compare the location information of the mobile terminal and the arrangement information of an exhibition object of interest and generate detailed information about the exhibition object of interest according to the comparison result.

The detailed-exhibit-information generator may generate detailed information about the exhibition object of interest when it is determined based on the arrangement information of the exhibition object of interest that a received location of the mobile terminal falls within a predetermined range from the exhibition object of interest.

The exhibition space mirroring module may mirror the viewing guide information to both the exhibition media display apparatus and the mobile terminal.

In another general aspect, there is provided an exhibition media display apparatus that communicates with an exhibition guide apparatus and a mobile terminal, the exhibition media display apparatus including: a media wall module configure to display a virtual exhibition hall based on viewing guide information mirrored from the exhibition guide apparatus; a tracking icon display configured to display a tracking icon corresponding to a location of a viewer tracked on a viewing route in the virtual exhibition hall, according to icon control information from the mobile terminal; and a detailed-exhibit-information display configured to compare location information of the tracking icon and arrangement information of a displayed particular exhibition object augmented onto the virtual exhibition hall and display detailed information about the particular exhibition object according to the comparison result.

The media wall module may display the virtual exhibition hall by augmenting the virtual exhibition hall with real exhibition objects according to the viewing guide information.

The detailed-exhibit-information display may display detailed information about the particular exhibition object when it is determined that a location of the tracking icon falls within a predetermined range from the particular exhibition object based on the arrangement information of the displayed particular exhibition object augmented onto the virtual exhibition hall.

The exhibition media display apparatus may further include a detailed-exhibit-information transmitter configured to transmit the detailed information about the particular exhibition object to the mobile terminal.

The exhibition media display apparatus may further include an exhibition display mirroring module configured to mirror exhibition display information to the mobile terminal wherein the exhibition display information contains at least one of the following: information about the displayed virtual exhibition hall, the tracking icon and the displayed detailed information about an exhibition object.

In yet another general aspect, there is provided a mobile terminal that communicates with an exhibition guide apparatus and an exhibition media display apparatus, the mobile terminal including: an icon control information generator configured to generate icon control information for controlling a movement of a tracking icon associated with identification information of the mobile terminal and displayed on the exhibition media display apparatus; and an icon control information transmitter configured to transmit the icon control information to the exhibition media display apparatus.

The mobile terminal may further include an exhibition space mirroring display configured to render exhibition display information mirrored from the exhibition media display apparatus and display the rendered information on a screen of the mobile terminal.

The exhibition space mirroring display may render viewing guide information mirrored from the exhibition guide apparatus and displays the rendered information to the screen of the mobile terminal.

The mobile terminal may further include a detailed-exhibit-information display configured to display on a screen thereof detailed information about an exhibition object that is received from the exhibition media display apparatus.

Other features and aspects will be apparent from the following detailed description, the drawings, and the claims.

### BRIEF DESCRIPTION OF THE DRAWINGS

FIG. 1 is a diagram illustrating a configuration of an exhibition guide system according to an exemplary embodiment.

FIG. 2 is a block diagram illustrating a configuration of an exhibition guide apparatus according to an exemplary embodiment.

FIG. 3 is a block diagram illustrating a configuration of an exhibition guide apparatus according to another exemplary embodiment.

FIG. 4 is a block diagram illustrating a configuration of an exhibition media display apparatus according to an exemplary embodiment.

FIG. 5 is a block diagram illustrating a configuration of a mobile terminal according to an exemplary embodiment.

FIG. 6 is a flowchart illustrating a method for guiding an exhibition according to an exemplary embodiment.

FIG. 7 is a flowchart illustrating a method for guiding an exhibition according to another exemplary embodiment.

FIG. 8 is a flowchart illustrating a method for guiding an exhibition according to another exemplary embodiment.

FIG. 9 is a flowchart illustrating a method for guiding an exhibition according to another exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description of exemplary embodiments is provided to assist in gaining a comprehensive understanding of the methods, apparatuses, and/or systems described herein. Accordingly, various changes, modifications, and equivalents of the methods, apparatuses, and/or systems described herein will be suggested to those of ordinary skill in the art, and should not be construed in a limiting sense.

Terms used throughout this specification are defined in consideration of functions according to exemplary embodiments, and can be varied according to a purpose of a user or manager, or precedent and so on. Therefore, definitions of the terms should be made on the basis of the overall context.

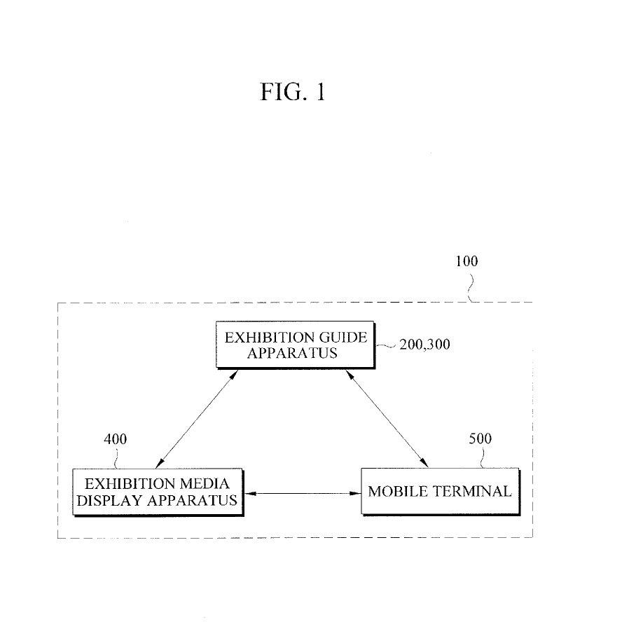

FIG. 1 is a diagram illustrating a configuration of an exhibition guide system according to an exemplary embodiment.

Referring to FIG. 1, the exhibition guide system 100 includes an exhibition guide apparatus 200, an exhibition media display apparatus 400 and a mobile terminal 500.

The exhibition guide system 100 may be installed in various exhibition spaces, such as museums, art museums, folk museums, expos, historic sites, palaces, and the like.

The exhibition guide apparatus 200 generates a virtual reality in which a virtual exhibition hall and a viewing route of the virtual exhibition hall are provided and mirrors the virtual exhibition hall and the viewing route to the exhibition media display apparatus 400 and/or the mobile terminal 500. In addition, the exhibition guide apparatus 200 stores information needed for generating the virtual exhibition hall (e.g., space information about the exhibition hall and information about arrangement (hereinafter, referred to as “arrangement information”) of the exhibition objects displayed in the exhibition hall) and information needed for generating a tracking icon (e.g., identification information of the mobile terminal), and manages the information by updating, deleting or performing other operations on the information.

The exhibition guide apparatus 200 may include an exhibition hall information database that stores data required for system operation and middle ware that connects and relays an external device and the database.

The exhibition guide apparatus 200 may be connected to the exhibition media display apparatus 400 over a wired or wireless network. The exhibition guide apparatus 200 may be connected to the mobile terminal 500 over a wired or wireless network. In one exemplary embodiment, the exhibition guide apparatus 200 may provide the same information to both the exhibition media display apparatus 400 and the mobile terminal 500.

The exhibition media display apparatus 400 displays thereon the virtual exhibition hall that is mirrored by the exhibition guide apparatus 200. In addition, the exhibition media display apparatus 400 displays the tracking icons transmitted from the exhibition guide apparatus 200 and controls the tracking icons in response to icon control information from the mobile terminal 500.

The exhibition media display apparatus 400 may be installed in indoor space, such as an exhibition space, where objects are displayed for the purpose of viewing, appreciation and/or evaluation. For example, the exhibition media display apparatus 400 may be a kiosk, a digital signage, a tele screen, or the combination thereof.

The exhibition media display apparatus 400 may be connected to the exhibition guide apparatus 200 over a wired or wireless network. The exhibition media display apparatus 400 may be connected to the mobile terminal 400 over a wireless network. For example, the wireless network may be a mobile communication network or a WiFi network.

The mobile terminal 500 generates icon control information for controlling the movement of a tracking icon associated with identification information of the mobile terminal 500 that is displayed on the exhibition media display apparatus 400 and transmits the icon control information to the exhibition media display apparatus 400.

The mobile terminal 500 transmits and receives information to and from the exhibition guide apparatus 200 and the exhibition media display apparatus 400 over a wireless network. For example, the wireless network may be a mobile communication network or a WiFi network.

The mobile terminal 500 may be a portable device that is capable of implementing various functions, such as a personal mobile communication service terminal, a personal digital assistant (PDA), a smartphone, a tablet computer, a laptop computer, a notebook computer, a wireless LAN terminal device, and smartglasses.

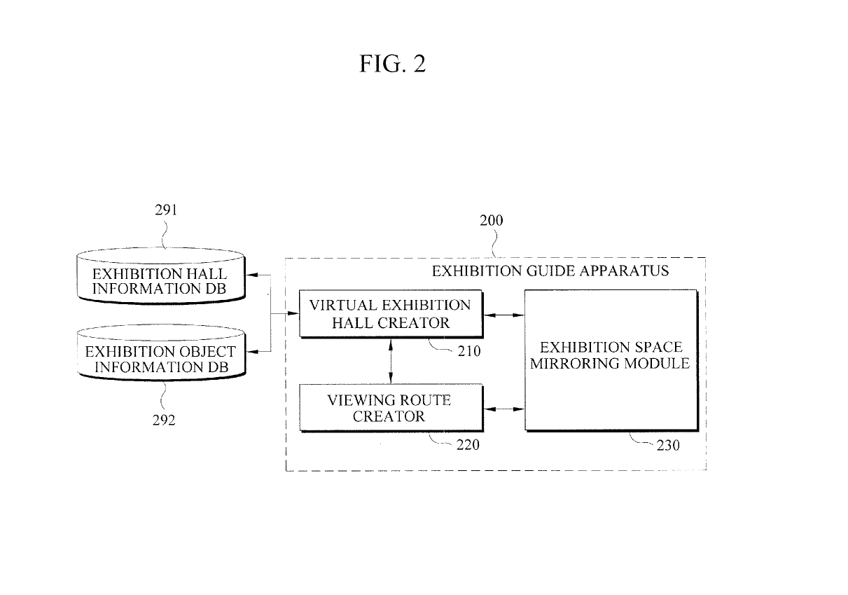

FIG. 2 is a block diagram illustrating a configuration of an exhibition guide apparatus according to an exemplary embodiment.

Referring to FIG. 2, the exhibition guide apparatus 200 includes a virtual exhibition hall creator 210, a viewing route creator 220, and an exhibition space mirroring module 230. The configuration of the exhibition guide apparatus 200 of FIG. 2 is only exemplary and only some of the modules shown in FIG. 2 and/or additional modules necessary for operations may be included in the exhibition guide apparatus 200. For example, the exhibition guide apparatus 200 may further include an exhibition image creator to create an image showing the exhibition state in an actual exhibition space using image information obtained by an imaging apparatus installed in the real exhibition space.

Although the virtual exhibition hall creator 210, a viewing route creator 220, and an exhibition space mirroring module 230 are described herein as independent modules, they may be implemented as a single form, a single physical device, or a single module. For example, the virtual exhibition hall creator 210, the viewing route creator 220, and the exhibition space mirroring module 230 may be implemented to be executed as individual processes or multiple processes on the same or separate servers. Furthermore, all elements may be implemented to be executed as a single process. Additionally, the virtual exhibition hall creator 210, the viewing route creator 220, and the exhibition space mirroring module 230 may be implemented as individual physical devices, or each may be implemented as a plurality of independent physical devices or a group of devices.

The virtual exhibition hall creator 210 may create a virtual exhibition hall using space information about the exhibition hall and a digital map that contains arrangement information of the exhibition objects displayed in the exhibition hall.

Here, the virtual exhibition hall may be metaverse. The metaverse is created by convergence of virtually enhanced physical reality and physically persistent virtual space. Thus, the virtual exhibition hall is the metaverse created by the convergence of virtually enhanced physical exhibition space and physically persistent virtual space. The metaverse can contain other content beyond the physical exhibition space, as well as accommodates all of the content contained in the physical exhibition space, and also can freely design the forms and configuration of content according to the purpose of exhibition.

In one exemplary embodiment, when a digital map is updated as the space information about the exhibition hall and the arrangement information of the exhibition objects displayed in the physical exhibition hall are updated, the virtual exhibition hall creator 210 may create a virtual exhibition hall using the updated digital map.

The virtual exhibition hall creator 210 may create the virtual exhibition hall by augmenting the virtual exhibition hall with real exhibition objects according to the arrangement information of the physical exhibition objects. That is, the entire physical exhibition space is provided as a virtual place, and the actual exhibition objects are provided in the virtual place via augmented reality (AR). In addition, detailed information about the physical exhibition object may be provided in the virtual place via AR.

The space information about the exhibition hall and the arrangement information of the exhibition objects displayed in the physical exhibition hall may be managed by the exhibition guide apparatus 200 in the form of a list or databases 291 and 292. Alternatively, the space information and the arrangement information may be managed by a separate external system, and the exhibition guide apparatus 200 may receive or acquire the space information and the arrangement information and use the information in creating the virtual exhibition hall.

The viewing route creator 220 may create one or more viewing routes according to the movement of a tracking icon that indicates the location of a viewer in the virtual exhibition hall.

Here, the “viewing route” indicates a path along which a virtual viewer may move to view exhibition objects in the virtual exhibition hall. For example, the actual exhibition hall is divided into an exhibition area where exhibition objects are arranged and displayed and a moving area where the viewers can move along and watch the exhibition objects. In the similar manner, the virtual exhibition hall is divided into a virtual exhibition area where the exhibition objects are exhibited and a virtual moving area where the virtual viewers can see the exhibition objects while moving, and the virtual moving area includes the “viewing mute.”

The viewing route may be represented in various forms in the virtual exhibition hall. For example, like the physical exhibition hall, the virtual exhibition hall may be created in such a manner that is distinctly divided into a virtual exhibition area and a virtual moving area. The implementation of the viewing route may not be limited to the aforementioned procedures, such that the viewing route may be implemented using a different method according to the purpose of exhibition or characteristics of exhibition objects. For example, the virtual exhibition hall may be created in such a manner that the virtual exhibition area and the virtual moving area are not clearly distinguished from each other.

Meanwhile, the “tracking icon” refers to a sign, a symbolic mark, an avatar or the like which indicates the virtual viewer who is moving along the viewing route in the virtual exhibition hall. The tracking icon may be generated corresponding to the identification information of the mobile terminal 500 carried by the actual viewer. The tracking icon may move under the control of the viewer. In one exemplary embodiment, the viewer may control the tracking icon via the exhibition media display apparatus 400. In another exemplary embodiment, the viewer may control the tracking icon via a separate tracking icon control apparatus.

In one exemplary embodiment, when the digital map is updated as the space information about the exhibition hall and the arrangement information of the exhibition objects displayed in the exhibition hall are updated, the virtual exhibition hall creator 210 creates the virtual exhibition hall using the updated digital map, and the viewing route creator 220 may create one or more viewing routes according to the type of generated virtual exhibition hall.

The created virtual exhibition hall and viewing routes may be stored in, updated and deleted from the database.

The exhibition space mirroring module 230 mirrors viewing guide information to the exhibition media display apparatus wherein the viewing guide information contains one or more of the following: information about the virtual exhibition hall, a viewing route and detailed information about exhibition objects.

Here, the “viewing guide information” may indicate information related to the virtual exhibition hall. More specifically, the viewing guide information may include all information that is required to represent the virtual exhibition hall formed via virtual reality, including the space information about the exhibition hall, the arrangement information of each exhibition object, detailed information about each exhibition object, the information about the virtual exhibition hall created by the virtual exhibition hall creator 210 and the information about the viewing route created by the viewing route creator 220. In addition, the viewing guide information may further include location information of the mobile terminal 500 and the number of tracking icons in the virtual exhibition hall.

Here, “mirroring information” means that information on one device is copied onto another device. Generally, “mirroring” indicates an operation of outputting an image or video that is currently displayed on a screen of one device, e.g., a smartphone, to another external display device. In the present disclosure, “mirroring” indicates an operation of outputting viewing guide information that has been configured from information about the physical exhibition hall to an external device without modification. The external device has a display capability.

In one exemplary embodiment, the exhibition space mirroring module 230 may mirror the viewing guide information into the viewing media display apparatus 400 and the mobile terminal 500.

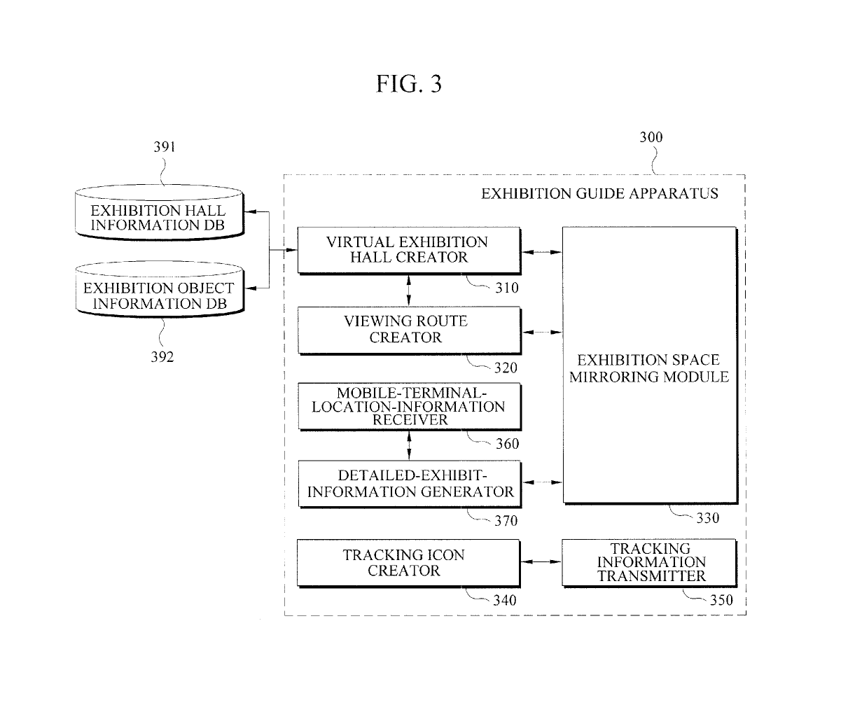

FIG. 3 is a block diagram illustrating a configuration of an exhibition guide apparatus according to another exemplary embodiment.

Referring to FIG. 3, the exhibition guide apparatus 300 may include a virtual exhibition hall creator 310, a viewing route creator 320, an exhibition space mirroring module 330, a tracking icon creator 340, a tracking information transmitter 350, a mobile-terminal-location-information receiver 360, and a detailed-exhibit-information generator 370. In addition, the configuration of the exhibition guide apparats 300 is only exemplary, and only some of the modules shown in FIG. 3 and/or additional modules necessary for operations may be included in the exhibition guide apparatus 300. For example, the exhibition guide apparatus 300 may further include an exhibition image creator to create an image showing the exhibition state in an actual exhibition space using image information obtained by an imaging apparatus installed in the real exhibition space.

The exhibition guide apparatus 300 of FIG. 3 differs from the exhibition guide apparatus 200 of FIG. 2 in that it further includes the tracking icon creator 340, the tracking information transmitter 350, the mobile-terminal-location-information receiver 360, and the detailed-exhibit-information generator 370. Hereinafter, the exhibition guide apparatus 300 of FIG. 3 is described with focus on the differences from the exhibition guide apparatus 200 of FIG. 2. Thus, the descriptions of elements of the exhibition guide apparatus 200 made with reference to FIG. 2 may apply to elements of the exhibition guide apparatus 300 of FIG. 3 that are not fully described, unless the application of the same description is unavailable due to the essential nature of the elements.

Although the virtual exhibition hall creator 310, the viewing route creator 320, a viewing space mirroring module 330, the tracking icon creator 340, the mobile-terminal-location-information receiver 360, and the detailed-exhibit-information generator 370 are described herein as independent entities, they may be implemented as a single form, a single physical device, or a single module. For example, the virtual exhibition hall creator 310, the viewing route creator 320, a viewing space mirroring module 330, the tracking icon creator 340, the mobile-terminal-location-information receiver 360, and the detailed-exhibit-information generator 370 may be implemented to be executed as individual processes or multiple processes on the same or separate servers. Furthermore, all elements may be implemented to be executed as a single process. Moreover, they may be implemented as individual physical devices, or each may be implemented as a plurality of independent physical devices or a group thereof.

The tracking icon creator 340 may create a tracking icon associated with identification information of the mobile terminal to indicate a location of the mobile terminal in the exhibition hall.

Here, the “tracking icon” refers to a sign, a symbolic mark, an avatar or the like which indicates the virtual viewer who is moving along the viewing route in the virtual exhibition hall. The tracking icon may be associated with the identification information of the mobile terminal 500 carried by the actual viewer. The tracking icon moves under the control of the viewer. In one exemplary embodiment, the viewer may control the tracking icon via the mobile terminal 500. In another exemplary embodiment, the viewer may control the tracking icon using the exhibition media display apparatus 400. In yet another exemplary embodiment, the viewer may control the tracking icon using a separate tracking icon control device.

The tracking icon created by the tracking icon creator 340 may move along the viewing route that has been created by the viewing route creator 320.

The tracking information transmitter 350 transmits tracking-related information that contains the tracking icon to both the exhibition media display apparatus 400 and the mobile terminal 500.

Here, the “tracking-related information” indicates information required for indicating the virtual viewer in the virtual exhibition hall, including the tracking icon. For example, the tracking-related information may include the identification number of the mobile terminal 500 based on which the tracking icon is made; information about an initial location of the tracking icon in the virtual exhibition hall; and shape information of the tracking icon.

The tracking information transmitter 250 transmits the tracking-related information that contains the tracking icon to the exhibition media display apparatus 400 over a wired network or a wireless network. Alternatively, the tracking information transmitter 250 transmits the tracking-related information that contains the tracking icon to the mobile terminal 500 over the wireless network.

The mobile-terminal-location-information receiver 360 receives location information of the mobile terminal 500.

While the viewer carrying the mobile terminal is moving in the physical exhibition space, the mobile terminal 500 may measure the current location thereof using an indoor positioning technology. The mobile terminal 500 transmits the measured current location thereof to the exhibition guide apparatus 300. In one exemplary embodiment, there is no limit to the method for measuring the current location, and any of well-known indoor positioning algorithms may be used to calculate the current location of the mobile terminal 500.

The indoor positioning method may be classified into three categories according to the wireless communication technology triangulation-based; proximity-based; and location-fingerprint-based methods. The triangulation-based method estimates a location of interest using a distance among three points. The proximity-based method includes a method of monitoring a wireless access point to recognize if a target object to be tracked is within coverage of one or more access points in a wireless cell network and a method of calling for information of a tag or automatic identification system, identifying the tag or system and estimating the location. The location-fingerprint-based method arbitrarily selects multiple locations using a fingerprint mechanism, and estimates a location of interest using information about signal intensities collected from the selected locations.

The detailed-exhibit-information generator 370 compares the location information of the mobile terminal with the arrangement information of an exhibition object of interest and generates detailed information about the exhibition object of interest according to the comparison result.

More specifically, the detailed-exhibit-information generator 370 may compare the location information of the mobile terminal and the arrangement information of the exhibition object, and when the comparison result shows that the viewer who is carrying the mobile terminal and moving around the exhibition space comes close to the exhibition object to view, the detailed-exhibit-information generator 370 may generate detailed information about said exhibition object.

In one exemplary embodiment, when the mobile terminal is placed near a particular exhibition object in the physical exhibition hall, the detailed-exhibit-information generator 370 may generate the detailed information about the exhibition object. In another exemplary embodiment, when the mobile terminal is placed near a particular exhibition object in the physical exhibition hall, the detailed-exhibit-information generator 370 may generate the detailed information about the exhibition object to be displayed via AR. In another exemplary embodiment, when it is determined based on the arrangement information particular exhibition object that a received location of the mobile terminal 500 falls within a predetermined range from the exhibition object, the detailed-exhibit-information generator 370 may generate detailed information about the particular exhibition object. In yet another exemplary embodiment, when it is shown based on the arrangement information of a particular exhibition object that the location of the mobile terminal does not change near the exhibition object for a predetermined period of time, the detailed-exhibit-information generator 370 may generate detailed information about the exhibition object, assuming that the viewer having the mobile terminal is viewing the exhibition object.

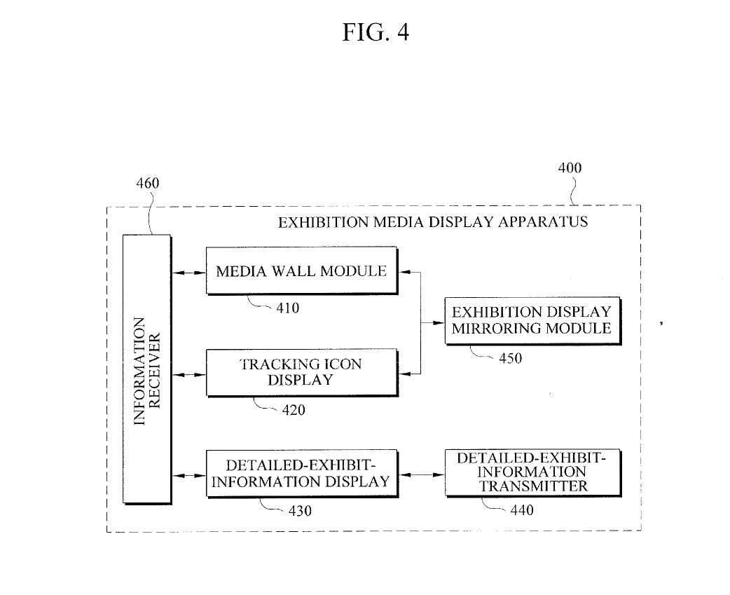

FIG. 4 is a block diagram illustrating a configuration of an exhibition media display apparatus according to an exemplary embodiment.

Referring to FIG. 4, the exhibition media display apparatus 400 includes a media wall module 410, a tracking icon display 420, and a detailed-exhibit-information display 430. In one aspect, the exhibition media display apparatus may further include a detailed-exhibit-information transmitter 440. In another aspect, the exhibition media display apparatus 400 may further include an exhibition display mirroring module 450.

In addition, the configuration of the exhibition media display apparatus 400 shown in FIG. 4 is exemplary, and only some of the modules shown in FIG. 4 and/or additional modules necessary for operations may be included in the exhibition media display apparatus 400. For example, the exhibition media display apparatus 400 may further include an information receiver 460 to receive information from the exhibition guide apparatus 200 or 300 and/or the mobile terminal 500.

Although the media wall module 410, the tracking icon display 420, the detailed-exhibit-information display 430, the detailed-exhibit-information transmitter 440, and the exhibition display mirroring module 450 are described herein as independent entities, they may be implemented as a single form, a single physical device, or a single module. For example, media wall module 410, the tracking icon display 420, the detailed-exhibit-information display 430, the detailed-exhibit-information transmitter 440, and the exhibition display mirroring module 450 may be implemented to be executed as individual processes or multiple processes on the same or separate servers. Furthermore, all elements may be implemented to be executed as a single process. Moreover, they may be implemented as individual physical devices, or each may be implemented as a plurality of independent physical devices or a group of physical devices.

The media wall module 410 displays a virtual exhibition hall thereon based on viewing guide information mirrored from the exhibition guide apparatus 200 or 300. In one exemplary embodiment, the media wall module 410 may display a viewing route based on the viewing guide information mirrored from the exhibition guide apparatus 200 or 300.

In another exemplary embodiment, the media wall module 410 may display a received tracking icon that has been transmitted from the exhibition guide apparatus 200 or 300. The tracking icon is associated with identification information of the mobile terminal 500 that is carried by a real viewer, indicating a virtual viewer who is viewing an exhibition object in a virtual exhibition hall. The tracking icon is moved under the control of the viewer. In the case where there are many viewers in the physical exhibition hall, there may also be a number of viewers in the virtual exhibition hall, and at this time, a plurality of tracking icons each associated with identification information of a mobile terminal of each viewer may be created and displayed. Moreover, the tracking icons for different viewers may be displayed in such a manner that can be distinguished from one another according to their corresponding viewers. For example, in the case where each tracking icon is an avatar that represents a viewer in the virtual exhibition hall, the plurality of tracking icons may be created as different avatars to represent different viewers. In another example, in the case where each tracking icon is the phone number of the mobile terminal 300 of a real viewer, the plurality of tracking icons may be created using the phone numbers to represent the virtual viewers.

In one exemplary embodiment, the initial position of the tracking icon in the virtual exhibition hall may correspond to a current location of the mobile terminal 500 carried by the viewer in the physical exhibition hall. For example, if the viewer with the mobile terminal 500 is standing near the entry of the physical exhibition hall, the initial position of the tracking icon that is displayed on the media wall module 410 of the exhibition media display apparatus 400 may be close to the entry of the virtual exhibition hall.

In another exemplary embodiment, the initial position of the tracking icon within the virtual exhibition hall may be a particular position regardless of the current location of the mobile terminal 500 carried by the viewer. For example, the initial position of the tracking icon that is displayed on the media wall module 410 of the exhibition media display apparatus 400 may be close to the entry of the virtual exhibition hall or a specific position in the virtual exhibition hall, regardless of the current location of the viewer who holds the mobile terminal 500.

In one aspect, the media wall module 410 may display the actual exhibition objects by augmenting the virtual exhibition hall with the real exhibition objects according to the viewing guide information. The entire exhibition space is provided as a virtual space, and the real exhibition objects are provided in the virtual space via AR. In addition, detailed information about the real exhibition objects may be provided in the virtual space via AR.

In another aspect, the media wall module 410 may receive the location information of the mobile terminal from the exhibition guide apparatus 200 or 300 and display traffic information.

In another aspect, the media wall module 410 may receive an exhibition image that shows the exhibition state of the real exhibition space from the exhibition guide apparatus 200 or 300 and display the exhibition image.

The tracking icon display 420 displays the tracking icon corresponding to the location of the viewer tracked on the viewing route in the virtual exhibition hall, according to the icon control information from the mobile termination 500. The tracking icon may move along the viewing route that is generated by the viewing route creator 220 or 320 of the exhibition guide apparatus 200 or 300. While the viewer is viewing the exhibition objects in the virtual exhibition hall, the tracking icon may move along the movement of the viewer on the viewing route according to the icon control information.

In one exemplary embodiment, the tracking icon display 420 may display the tracking icon according to the icon control information from the mobile terminal 500 carried by the viewer. In another exemplary embodiment, the tracking icon display 420 may display the tracking icon according to information about the immediate control of the viewer to the icon via use of the exhibition media display apparatus 400. In yet another exemplary embodiment, the tracking icon display 420 may display the tracking icon according to icon control information from an individual tracking icon control device that is carried by the viewer.

In one exemplary embodiment, the tracking icon display 420 may display only the movement of the tracking icon. More specifically, the tracking icon display 420 may not display a route of the tracking icon that has taken along the viewing route in the virtual exhibition hall, but only a current location of the tracking icon.

In another exemplary embodiment, the tracking icon display 420 may continuously display the tracking icon while tracking the route of the tracking icon in motion. At this time, the icon control information from the mobile terminal 500 may request to trackback the route of the tracking icon. For example, if the viewer wants to traces back the viewing route to watch the exhibition object that the viewer has already passed, the viewer may use a path that the tracking icon display 420 has displayed while tracking the route of the tracking icon.

The detailed-exhibit-information display 430 compares the location information of the tracking icon with the arrangement information of the displayed exhibition objects augmented onto the virtual exhibition hall, and display detailed information about an exhibition object of interest according to the comparison result.

More specifically, the detailed-exhibit-information display 430 may compare the location information of the tracking icon and the arrangement information of the exhibition object, and when the comparison result shows that the viewer who is moving around the exhibition space, carrying the mobile terminal, comes close to the exhibition object to view, the detailed-exhibit-information display 430 may generate detailed information about said exhibition object.

In one exemplary embodiment, when the tracking icon is positioned near a particular exhibition object in the virtual exhibition hall, the detailed-exhibit-information display 430 may display detailed information about the particular exhibition object. In another exemplary embodiment, when the tracking icon is positioned near a particular exhibition object in the virtual exhibition hall, the detailed-exhibit-information display 430 may display detailed information about the particular exhibition object via AR. In yet another exemplary embodiment, when it is determined, based on the arrangement information of the displayed particular exhibition object augmented onto the virtual exhibition hall, that the location of the tracking icon falls within a predetermined range from the particular exhibition object, the detailed-exhibit-information display 430 may display detailed information about the particular exhibition object. In yet another exemplary embodiment, when it is shown that the location of the tracking icon does not change near a particular exhibition object in the virtual exhibition hall for a predetermined period of time, the detailed-exhibit-information display 430 may display detailed information about the exhibition object, assuming that the corresponding virtual viewer is viewing said exhibition object.

In one aspect, the detailed-exhibit-information display 430 may display detailed information about an exhibit object that is transmitted from the exhibition guide apparatus 200 or 300. The detailed exhibit information is detailed information about an exhibition object according to the location information of the mobile terminal 500. More specifically, the exhibition guide apparatus 200 or 300 may compare the location information of the mobile terminal and the arrangement information of an exhibition object of interest, and the exhibition media display apparatus 400 may receive and display detailed information about the exhibition object of interest that has been generated according to the comparison result.

In one exemplary embodiment, the exhibition media display apparatus 400 may further include the detailed-exhibit-information transmitter 440.

The detailed-exhibit-information transmitter 440 transmits detailed information about an exhibit object to the mobile terminal 500. More specifically, the detailed-exhibit-information transmitter 440 may transmit detailed information about an exhibition object that is displayed by the detailed-exhibit-information display 430 to the mobile terminal 500. A viewer having the mobile terminal 500 may check the detailed information about an exhibition object that is displayed on the exhibition media display apparatus 400. In addition, the viewer having the mobile terminal 500 may check the detailed information about an exhibition object that is transmitted to the mobile terminal.

In one exemplary embodiment, the detailed information about an exhibition object that is displayed on the exhibition media display apparatus 400 may be the same as the detailed information about an exhibition object that is transmitted to the mobile terminal 500. In another exemplary embodiment, the detailed information about an exhibition object that is displayed on the exhibition media display apparatus 400 may be different from the detailed information about an exhibition object that is transmitted to the mobile terminal 500. For example, detailed information about an exhibition object transmitted to the mobile terminal 500 may further contain additional information of the exhibition object that has not been displayed on the exhibition media display apparatus 400.

The detailed-exhibit-information transmitter 440 transmits the information to the mobile terminal 500 over a wireless network. For example, the wireless networks may be a mobile communication network or a wireless Internet (e.g., WiFi) network.

In one aspect, the exhibition media display apparatus 400 may further include the exhibition display mirroring module 450.

The exhibition display mirroring module 450 mirrors exhibition display information to the mobile terminal 500 wherein the exhibition display information contains at least one of the following: information about the displayed virtual exhibition hall, the tracking icon and the displayed detailed information about an exhibition object.

Here, the “exhibition display information” refers to items displayed on the exhibition media display apparatus 400, such as the displayed virtual exhibition hall, the displayed viewing route, the displayed tracking icon, and detailed information about an exhibition object. The exhibition display information may further include a tracking icon transmitted from the exhibition guide apparatus 200 or 300 and a tracking icon that tracks the viewing route in the virtual exhibition hall according to the icon control information from the mobile terminal 500.

In addition, “mirroring” indicates an operation of outputting an image or video that is currently displayed on the exhibition media display apparatus 400 to the mobile terminal 500 without modification. For example, the exhibition display mirroring module 450 may mirror the same content as that displayed on the exhibition media display apparatus 400 to the mobile terminal 500. The mobile terminal 500 may display on its screen the same content as that displayed on the exhibition media display apparatus 400. In another example, the exhibition display mirroring module 450 may mirror to the mobile terminal 500 the content that is not displayed on the exhibition media display apparatus 400 but available to be displayed on the exhibition media display apparatus 400. The mobile terminal 500 may display on its screen the content that is not displayed on the exhibition media display apparatus 400, as well as the content displayed on the exhibition media display apparatus 400.

The exhibition display mirroring module 450 transmits information to the mobile terminal 500 over a wireless network. For example, the wireless network may be a mobile communication network and a wireless Internet (WiFi) network.

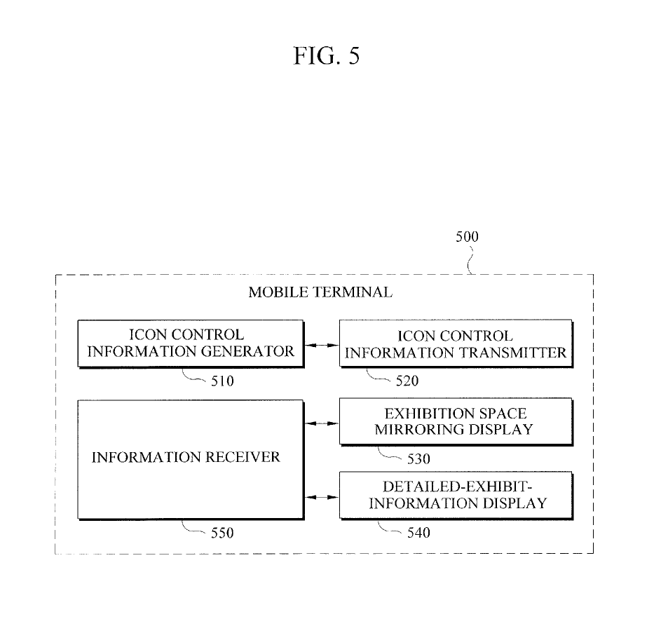

FIG. 5 is a block diagram illustrating a configuration of a mobile terminal according to an exemplary embodiment.

Referring to FIG. 5, the mobile terminal 500 includes an icon control information generator 510 and an icon control information transmitter 520. In one exemplary embodiment, the mobile terminal 500 may further include an exhibition space mirroring display 530. In another exemplary embodiment, the mobile terminal 500 may further include a detailed-exhibit-information display 540.

In addition, the configuration of the mobile terminal 500 of FIG. 5 is only exemplary and only some of the modules shown in FIG. 5 and/or additional modules necessary for operations may be included in the mobile terminal 500. For example, the mobile terminal 500 may further include information receiver 550 to receive information from the exhibition guide apparatus 200 or 300 and/or the exhibition media display apparatus 400, and a positioning module to measure a current position of the mobile terminal 500.

The icon control information generator 510, the icon control information transmitter 520, the exhibition space mirroring display 530, and the detailed-exhibit-information display 540 are described herein as independent modules, they may be implemented as a single form, a single physical device, or a single module. For example, The icon control information generator 510, the icon control information transmitter 520, the exhibition space mirroring display 530, and the detailed-exhibit-information display 540 may be implemented to be executed as individual processes or multiple processes on the same or separate servers. Furthermore, all elements may be implemented to be executed as a single process. Moreover, the icon control information generator 510, the icon control information transmitter 520, the exhibition space mirroring display 530, and the detailed-exhibit-information display 540 may be implemented as individual physical devices, or each may be implemented as a plurality of independent physical devices or a group of physical devices.

The icon control information generator 510 generates icon control information for controlling a movement of a tracking icon associated with identification information of the mobile terminal 500 and displayed on the exhibition media display apparatus 400. The tracking icon is associated with the identification information of the mobile terminal 500 that is carried by a real viewer, and the tracking icon represents a virtual viewer in the virtual exhibition hall. The tracking icon moves under the control of the viewer. The viewer may generate icon control information to control the tracking icon.

Here, the “icon control information” indicates information for controlling the tracking icon to move along a viewing route, wherein the tracking icon represents the virtual viewer in the virtual exhibition hall displayed on the exhibition media display apparatus 400. For example, the icon control information generator 510 may generate icon control information to move the tracking icon to left, right, up and down along the viewing route in the virtual exhibition hall. In another example, the icon control information generator 510 may generate icon control information to make a tracking icon appear in the virtual exhibition hall or disappear from the virtual exhibition hall as the virtual viewer finishes the viewing.

The icon control information transmitter 520 transmits the icon control information to the exhibition media display apparatus 400. The icon control information transmitter 520 transmits the information to the exhibition media display apparatus 400 over a wireless network. For example, the wireless network may be a mobile communication network and a wireless Internet (WiFi) network.

In one exemplary embodiment, the mobile terminal 500 may further include exhibition space mirroring display 530.

The exhibition space mirroring display 530 renders the exhibition display information mirrored from the exhibition media display apparatus 400 and displays the rendered information on the screen of the mobile terminal.

Here, “rendering the mirrored exhibition display information” means that the exhibition display information mirrored from the exhibition media display apparatus 400 is adjusted to be optimally displayed on the screen of the mobile terminal 500 owned by the viewer. For example, the exhibition space mirroring display 530 may display on its screen the exhibition display information mirrored from the exhibition media display apparatus 400 by adjusting a screen size, a screen resolution, colors, a screen rotation direction, text or the like.

In one exemplary embodiment, the exhibition space mirroring display 530 may mirror viewing guide information that has been mirrored from the exhibition guide apparatus 200 or 300 again to the mobile terminal 500. The mobile terminal 500 may allow displays the mirrored viewing guide information on its screen. For example, the exhibition space mirroring display 530 may allow the mobile terminal 500 to display on its screen the same content as that displayed on the exhibition media display apparatus 400 by mirroring the same content as that displayed on the exhibition media display apparatus 400 to the mobile terminal 500. In another example, the exhibition space mirroring display 530 may allow the mobile terminal 500 to display on its screen content that is not yet displayed on the exhibition media display apparatus 400 as well as the already displayed content by mirroring to the mobile terminal 500 the content that has not been displayed but is available to be displayed on the exhibition media display apparatus 400.

In one aspect, the mobile terminal 500 may further include the detailed-exhibit-information display 540.

The detailed-exhibit-information display 540 displays detailed information about an exhibition object that is transmitted from the exhibition media display apparatus 400. The detailed-exhibit-information display 540 receives information from the exhibition media display apparatus 400 over a wireless network. For example, the wireless network may be a mobile communication network and a wireless Internet (WiFi) network.

More specifically, the detailed-exhibit-information display 540 may receive the detailed information about an exhibition object that is displayed by the detailed-exhibit-information display 430 of the exhibition media display apparatus 400, and display the received detailed information on the screen of the mobile terminal 500. For example, the viewer having the mobile terminal 500 may check the detailed information about an exhibition object that is displayed on the exhibition media display apparatus 400. In addition, the viewer having the mobile terminal 500 may check detailed information about an exhibition object that is received through the detailed-exhibit-information display 540.

In one exemplary embodiment, the detailed information about an exhibition object that is displayed on the exhibition media display apparatus 400 may be the same as the detailed information about an exhibition object received by the mobile terminal 500. In another exemplary embodiment, the detailed information about an exhibition object may be different from the detailed information about the exhibition object received by the mobile terminal 500. In yet another exemplary embodiment, the detailed information about an exhibition object that the mobile terminal 500 receives may further include additional information of an exhibition object that has not been displayed on the exhibition media display apparatus 400.

In one exemplary embodiment, the detailed-exhibit-information display 540 may display the detailed information about an exhibition object from the exhibition media display apparatus 400 via AR.

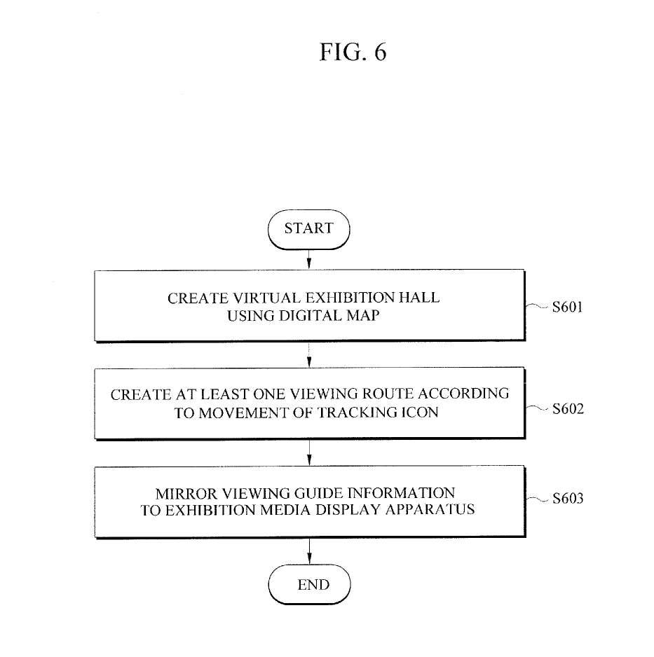

FIG. 6 is a flowchart illustrating a method for guiding an exhibition according to an exemplary embodiment. The procedures described herein may be implemented in various forms, including the present exemplary embodiment. The method for guiding an exhibition as illustrated in FIGS. 6 to 8 may be implemented using the exhibition guide apparatuses 200 and 300 of FIG. 2 and FIG. 3 or electronic devices including the exhibition guide apparatus. Thus, the method will be described briefly with the understanding that detailed descriptions of some procedures and operations thereof that are not fully described hereinafter can be obtained with reference to FIGS. 1 to 5.

Referring to FIG. 6, the method for guiding an exhibition using the exhibition guide apparatus 200 or 300, the exhibition media display apparatus 400, and the mobile terminal 500 may include operations of: creating a virtual exhibition hall using a digital map that contains space information about a physical exhibition hall and arrangement information of exhibition objects displayed in the exhibition hall as depicted in S601; creating one or more viewing routes according to the movement of a tracking icon that indicates a location of a viewer in the virtual exhibition hall as depicted in S602; and mirroring viewing guide information to the exhibition media display apparatus wherein the viewing guide information contains at least one of the following: information about the virtual exhibition hall, the viewing route, and detailed information about exhibition objects as depicted in S603.

In S601, the virtual exhibition hall is created using the digital map that contains the space information about the exhibition hall and the arrangement information of exhibition objects displayed in the exhibition hall. In one exemplary embodiment, in S601, when the digital map is updated as the space information and the arrangement information are updated, the virtual exhibition hall in a virtual reality may be created using the updated digital map. In one exemplary embodiment, in S601, the virtual exhibition hall may be created by augmenting the virtual exhibition hall with real exhibition objects according to the arrangement information of exhibition objects. The entire exhibition hall is provided as a virtual space, and the real exhibition objects are provided in the virtual space via AR. In addition, detailed information about each real exhibition object may be provided to the virtual space via AR.

In S602, one or more viewing routes are created according to the movement of a tracking icon that indicates a location of a viewer in the virtual exhibition hall. The tracking icon may be associated with identification information of the mobile terminal owned by a real viewer. In one exemplary embodiment, when the digital map is updated as the space information about the exhibition hall and the arrangement information of exhibition objects displayed in the exhibition hall are updated, the virtual exhibition hall may be created using the updated digital map in S601, and at least one viewing route may be generated according to the type of generated virtual exhibition hall in S602.

In S603, the viewing guide information that includes at least one of the following: information about the virtual exhibition hall, the viewing route, and detailed information about exhibition object may be mirrored to the exhibition media display apparatus. In one exemplary embodiment, in S603, the viewing guide information may be mirrored to both the exhibition media display apparatus and the mobile terminal.

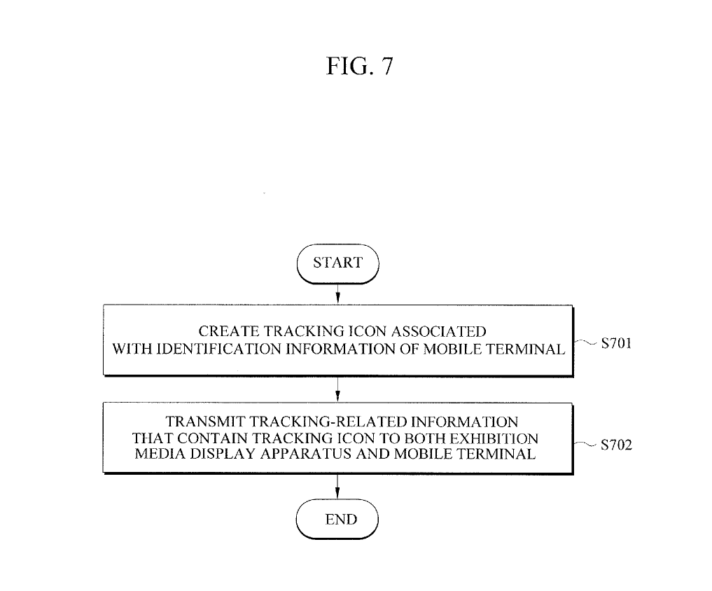

FIG. 7 is a flowchart illustrating a method for guiding an exhibition according to another exemplary embodiment.

Referring to FIG. 7, in addition to the operations of the method shown in FIG. 6, the method for guiding an exhibition may further include operations of: creating a tracking icon that is related to viewing exhibition and associated with identification information of a mobile terminal as depicted in S701, and transmitting tracking-related information that contains the tracking icon to the exhibition media display apparatus and the mobile terminal as depicted in S702.

In S701, the tracking icon associated with identification information of the mobile terminal is created to indicate viewing of a virtual exhibition. Here, the “tracking icon” refers to a sign, a symbolic mark, an avatar or the like which indicates the virtual viewer who is moving along the viewing route in the virtual exhibition hall. The tracking icon may be generated corresponding to the identification information of the mobile terminal carried by the actual viewer.

Then, the tracking-related information that contains the tracking icon to both the exhibition media display apparatus and the mobile terminal in S702. Here, the “tracking-related information” indicates information required for indicating the virtual viewer in the virtual exhibition hall, including the tracking icon. For example, the tracking-related information may include the identification number of the mobile terminal based on which the tracking icon is made; information about an initial location of the tracking icon in the virtual exhibition hall; and shape information of the tracking icon.

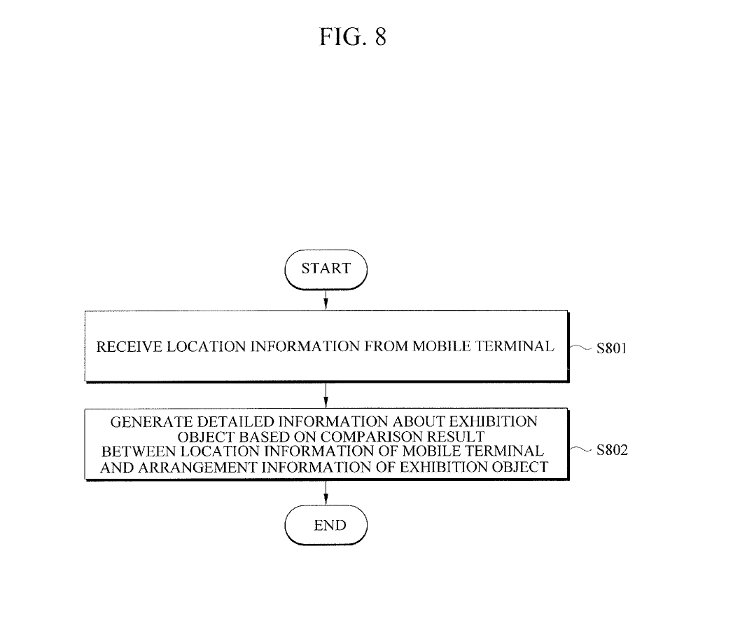

FIG. 8 is a flowchart illustrating a method for guiding an exhibition according to another exemplary embodiment.

Referring to FIG. 8, in addition to the operations of the method shown in FIG. 6, the method of FIG. 8 may further include operations of: receiving from the mobile terminal its location information as depicted in S801 and generating detailed information about an exhibition object of interest according to comparison result between the location information of the mobile terminal and arrangement information of the exhibition object as depicted in S802.

In S801, the location information is received from the mobile terminal. While the real viewer with the mobile terminal is moving around the physical exhibition space, the mobile terminal 500 may measure its current position using an indoor positioning technology. The mobile terminal may transmit the measured current location thereof to the exhibition guide apparatus. In one exemplary embodiment, there is no limit to the method for measuring the current location, and any of well-known indoor positioning algorithms may be used to calculating a current location of the mobile terminal.

Then, in S802, the location information of the mobile terminal and the arrangement information of an exhibition object of interest are compared and the detailed information about the exhibition object is generated according to the comparison result. At this time, when the received location of the mobile terminal falls within a predetermined range from the exhibition object based on the arrangement information of the exhibition object, the detailed information about the exhibition object may be generated.

In one exemplary embodiment, in S802, when the mobile terminal is placed near a particular exhibition object in the physical exhibition hall, the detailed information about the exhibition object may be generated to be displayed via AR. In another exemplary embodiment, in S802, when it is determined based on the arrangement information of a particular exhibition object that a received location of the mobile terminal falls within a predetermined range from the exhibition object, detailed information about the particular exhibition object may be generated. In yet another exemplary embodiment, in S802, when it is shown based on the arrangement information of a particular exhibition object that the location of the mobile terminal does not change near the exhibition object for a predetermined period of time, detailed information about the exhibition object may be generated, assuming that the viewer having the mobile terminal is viewing the exhibition object.

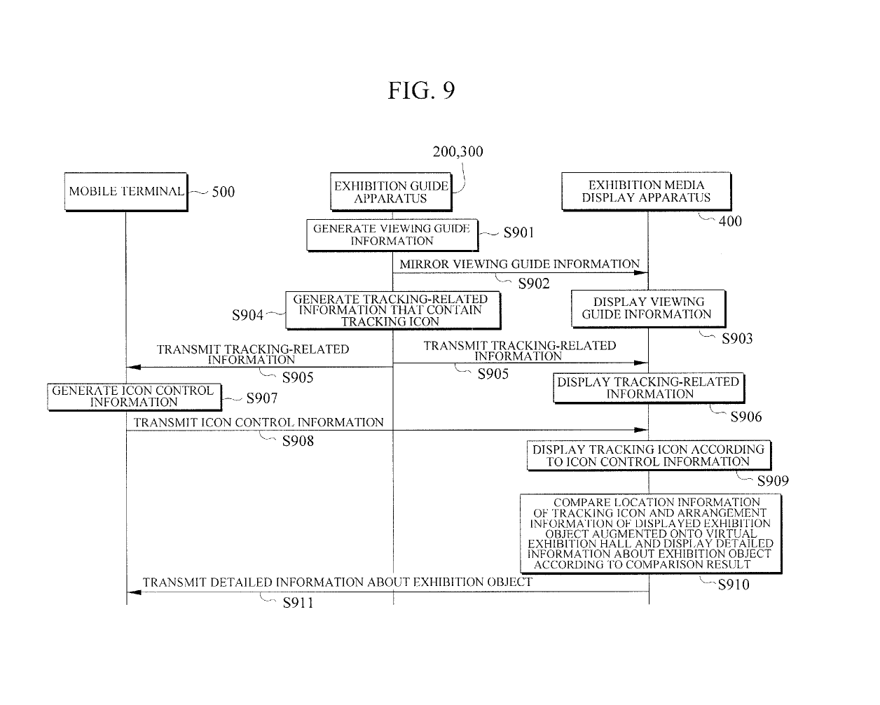

FIG. 9 is a flowchart illustrating a method for guiding an exhibition according to another exemplary embodiment.

The procedures described herein may be implemented in various forms, including the present exemplary embodiment. The method for guiding an exhibition as illustrated in FIG. 9 may be implemented using the exhibition guide apparatuses 200 and 300 of FIG. 2 and FIG. 3, the exhibition media display apparatus 400 of FIG. 4, the mobile terminal 500 of FIG. 5, or electronic devices including the aforementioned apparatuses. Therefore, the method will be described briefly with the understanding that detailed descriptions of some procedures and operations thereof that are not fully described hereinafter can be obtained with reference to FIGS. 1 to 5.

Referring to FIG. 9, in S901, the exhibition guide apparatus generates viewing guide information that contains at least one of the following: information about a virtual exhibition hall, a viewing route, and detailed information about an exhibition object.

Then, in S902 the exhibition guide apparatus mirrors the viewing guide information to the exhibition media display apparatus 400, and then the exhibition media display apparatus 400 displays the mirrored viewing guide information in S903.

In S904, the exhibition guide apparatus generates tracking-related information that contains the tracking icon, and transmits the tracking-related information to the exhibition media display apparatus and the mobile terminal as depicted in S905.

In S906, the exhibition media display apparatus displays the tracking icon.

In S907, the mobile terminal generates icon control information and transmits it to the exhibition media display apparatus as depicted in S908. Then in S909, the exhibition media display apparatus displays the tracking icon according to the icon control information.

In S910, the exhibition media display apparatus compares the location information of the tracking icon and the arrangement information of a displayed exhibition object that is augmented over the virtual exhibition hall and displays detailed information of the exhibition object according to the comparison result. Then in S911, the exhibition media display apparatus transmits the detailed information to the mobile terminal.

As described above, according to the exemplary embodiments, it is possible to provide a physical exhibition space as a virtual space and augment the virtual space with real exhibition objects.

Also, it is possible to enable viewers to view the exhibition objects in the virtual exhibition hall according to their own purposes.

Moreover, it is possible to enable the viewers to obtain information about layouts and conditions of the actual exhibition space and exhibition objects without physically visiting the “real-world” exhibition hall.

The methods for guiding an exhibition using an exhibition guide apparatus, an exhibition media display apparatus, and a mobile terminal that are described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. The media may also be a transmission medium such as optical or metallic lines, wave guides, and the like including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations and methods described above.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced nr supplemented by other components or their equivalents. Accordingly, other implementations are within the scope of the following claims.

What is claimed is:

1. An exhibition guide apparatus that communicates with an exhibition media display apparatus and a mobile terminal, the exhibition guide apparatus comprising:
a virtual exhibition creator configured to create a virtual exhibition hall using a digital map that contains space information about an exhibition hall and arrangement information of exhibition objects displayed in the exhibition hall;
a viewing route creator configured to create at least one viewing route according to a movement of a tracking icon that indicates a location of a user in the virtual exhibition hall; and
an exhibition space mirroring module configured to mirror viewing guide information to the exhibition media display apparatus, the viewing guide information containing at least one of the following: information about the virtual exhibition hall, the viewing route and detailed information about an exhibition hall.

2. The exhibition guide apparatus of claim 1, wherein the virtual exhibition hall creator creates the virtual exhibition hall by augmenting the virtual exhibition hall with real exhibition objects according to the arrangement information of exhibition objects.

3. The exhibition guide apparatus of claim 1, further comprising:
a tracking icon creator configured to create the tracking icon associated with identification information of the mobile terminal to indicate a location of the mobile terminal in the exhibition hall; and
a tracking information transmitter configured to transmit tracking-related information that contains the tracking icon to both the exhibition media display apparatus and the mobile terminal.

4. The exhibition guide apparatus of claim 1, further comprising:
a mobile-terminal-location-information receiver configured to receive mobile terminal's location information from the mobile terminal; and
a detailed-exhibit-information generator configured to compare the location information of the mobile terminal and the arrangement information of an exhibition object of interest and generate detailed information about the exhibition object of interest according to the comparison result.

5. The exhibition guide apparatus of claim 4, wherein the detailed-exhibit-information generator generates detailed information about the exhibition object of interest when it is determined based on the arrangement information of the exhibition object of interest that a received location of the mobile terminal falls within a predetermined range from the exhibition object of interest.

6. The exhibition guide apparatus of claim 1, wherein the exhibition space mirroring module mirrors the viewing guide information to both the exhibition media display apparatus and the mobile terminal.

7. An exhibition media display apparatus that communicates with an exhibition guide apparatus and a mobile terminal, the exhibition media display apparatus comprising:
a media wall module configure to display a virtual exhibition hall based on viewing guide information mirrored from the exhibition guide apparatus;
a tracking icon display configured to display a tracking icon corresponding to a location of a viewer tracked on a viewing route in the virtual exhibition hall, according to icon control information from the mobile terminal; and
a detailed-exhibit-information display configured to compare location information of the tracking icon and arrangement information of a displayed particular exhibition object augmented onto the virtual exhibition hall and display detailed information about the particular exhibition object according to the comparison result.

8. The exhibition media display apparatus of claim 7, wherein the media wall module displays the virtual exhibition hall by augmenting the virtual exhibition hall with real exhibition objects according to the viewing guide information.

9. The exhibition media display apparatus of claim 7, wherein the detailed-exhibit-information display displays detailed information about the particular exhibition object when it is determined that a location of the tracking icon falls within a predetermined range from the particular exhibition object based on the arrangement information of the displayed particular exhibition object augmented onto the virtual exhibition hall.

10. The exhibition media display apparatus of claim 7, further comprising:
a detailed-exhibit-information transmitter configured to transmit the detailed information about the particular exhibition object to the mobile terminal.

11. The exhibition media display apparatus of claim 7, further comprising:
an exhibition display mirroring module configured to mirror exhibition display information to the mobile terminal wherein the exhibition display information contains at least one of the following: information about the displayed virtual exhibition hall, the tracking icon and the displayed detailed information about an exhibition object.

12. A mobile terminal that communicates with an exhibition guide apparatus and an exhibition media display apparatus, the mobile terminal comprising:
an icon control information generator configured to generate icon control information for controlling a movement of a tracking icon associated with identification information of the mobile terminal and displayed on the exhibition media display apparatus; and
an icon control information transmitter configured to transmit the icon control information to the exhibition media display apparatus.

13. The mobile terminal of claim 12, further comprising:
an exhibition space mirroring display configured to render exhibition display information mirrored from the exhibition media display apparatus and display the rendered information on a screen of the mobile terminal.

14. The mobile terminal of claim 13, wherein the exhibition space mirroring display renders viewing guide information mirrored from the exhibition guide apparatus and displays the rendered information to the screen of the mobile terminal.

15. The mobile terminal of claim 12, further comprising:
a detailed-exhibit-information display configured to display on a screen thereof detailed information about an exhibition object that is received from the exhibition media display apparatus.

16. A method for guiding an exhibition using an exhibition guide apparatus, an exhibition media display apparatus and a mobile terminal, the method comprising:
creating a virtual exhibition hall using a digital map that contains space information about an exhibition hall and arrangement information of exhibition objects displayed in the exhibition hall;
creating at least one viewing route according to a movement of a tracking icon that indicates a location of a user in the virtual exhibition hall; and
mirroring viewing guide information to the exhibition media display apparatus, the viewing guide information containing at least one of the following: information about the virtual exhibition hall, the viewing route and detailed information about an exhibition hall.

17. The method of claim 16, wherein the creating of the virtual exhibition hall comprises augmenting the virtual exhibition hall with real exhibition objects according to the arrangement information of exhibition objects to create the virtual exhibition hall.

18. The method of claim 16, further comprising:
creating the tracking icon associated with identification information of the mobile terminal to indicate a location of the mobile terminal in the exhibition hall; and
transmitting tracking-related information that contains the tracking icon to both the exhibition media display apparatus and the mobile terminal.

19. The method of claim 16, further comprising:
receiving mobile terminal's location information from the mobile terminal; and
comparing the location information of the mobile terminal and the arrangement information of an exhibition object of interest and generating detailed information about the exhibition object of interest according to the comparison result.

20. The method of claim 19, wherein in the generating of the detailed information of the exhibition object of interest, the detailed information is generated when it is determined based on the arrangement information of the exhibition object of interest that a received location of the mobile terminal falls within a predetermined range from the exhibition object of interest.
